(19) United States
(12) Patent Application Publication
(10) Pub. No.: US 2004/0084377 A1
(43) Pub. Date: May 6, 2004

(54) Method and apparatus for regenerating fire resistant hydraulic fluid containing water-glycol

(76) Inventors: Gary R. Walker, Oneonta, AL (US); Jim O. Ackerman, Trussville, AL (US)

Correspondence Address: Gary R. Walker, 992 County Hwy. 12, Oneonta, AL, 35121, US

(21) Appl. No.: 10/288,109

(22) Filed: Nov. 5, 2002

(51) Int. Cl. C02F 1/28

(52) U.S. Cl. 210/663; 210/266

(57) ABSTRACT

A method and apparatus for regenerating contaminated or spent water-glycol fluid used as a fire resistant hydraulic fluid. The spent fluid is delivered to a process tank and allowed to settle so that oil floats to the surface and can be skimmed off and removed. Water can be deionized and added to the process tank if necessary. The fluid is pumped out of the process tank and passed through progressively smaller particulate filters and then through a filter media bed for removal of oils, grease, hydrocarbons, dissolved hydrocarbons, hydrolyzed acids, solvents and organic compounds. The purified fluid is delivered to a finish tank to which metered amounts of specified additives can be supplied.

### FIELD OF THE INVENTION

This invention relates generally to fire resistant hydraulic fluids and more particularly to a method and apparatus for regenerating spent or contaminated water-glycol used as a fire resistant hydraulic fluid.

### BACKGROUND OF THE INVENTION

Water-glycol fluid is commonly used as a fire resistant hydraulic fluid in applications where fire resistance of the fluid is critical. The fluid is usually either ethylene glycol or diethylene glycol. The fire resistant fluid inevitably becomes spent through use and/or contamination by materials such as oil, grease, hydrocarbons, hydrolyzed acids, solvents and organic compounds, as well as by dirt, sand, grit and other particulate materials. In view of the relatively high cost of ethylene glycol and diethylene glycol fluids, considerable expense can be avoided by economically regenerating the spent or contaminated fluid.

Accordingly, it is a principal goal of the present invention to provide a method and apparatus for effectively and economically regenerating spent or contaminated water-glycol used as a fire resistant hydraulic fluid.

### BRIEF SUMMARY OF THE INVENTION

It is an important object of the present invention to provide a method and apparatus for regenerating water-glycol fluid in a way to assure proper viscosity, the removal of particulate materials, the absence of contaminants such as oil, hydrocarbons, grease, hydrolyzed acids, solvents and organic compounds, and to accommodate additives that are specified for the fluid.

It is another object of the invention to provide a method and apparatus of the character described that can be implemented either as a stationary facility or a mobile or portable facility, depending upon the application to which it is to be put.

In accordance with the invention, these objects are achieved by directing the spent water-glycol fluid into a process tank in which oil can be skimmed from the surface and removed. The fluid in the tank can be sampled through a sampling port, and water can be added through a suitable inlet line if it is needed to bring the fluid to the proper viscosity. The water can be tap water which can be deionized by passage through cation and anion vessels.

From the process tank, the fluid may then be pumped through a five micron filter and then through a one micron filter to first filter out larger particles and then smaller particles of grit and other particulate contaminants. Next, the fluid can be pumped through an activated clay filter bed to remove contaminants such as oil, grease, hydrocarbons, dissolved hydrocarbons, hydrolyzed acids, solvents and organic compounds.

Finally, the purified fluid is delivered to a finish tank from which sampling can be effected through a sampling port. Additives can be applied to the fluid in the finish tank according to specifications for the fluid, and further samples can be tested for compliance with the additive specifications.

### BRIEF DESCRIPTION OF THE SEVERAL VIEWS OF THE DRAWING

The accompanying drawing which forms a part of the specification and is a diagrammatic view of an apparatus that may be used in accordance with a preferred embodiment of the present invention to regenerate spent water-glycol used as a fire resistant hydraulic fluid.

### DETAILED DESCRIPTION OF THE INVENTION

In accordance with the present invention, a process tank 10 is provided in order to contain spent or contaminated water-glycol fluid that is used as a fire resistant hydraulic fluid. The water-glycol fluid is supplied into the tank 10 near its bottom through an inlet line 12. The water-glycol fluid may be either ethylene glycol or diethylene glycol or a related glycol based fire resistant hydraulic fluid.

In the tank 10, the fluid is allowed to settle for a time period that is long enough to allow oil 14 to float to the top surface of the fluid in the tank 10. The layer of oil 14 is skimmed from the top surface of the fluid in tank 10 by a conventional oil skimmer 16 that connects with a skimmer belt 18 located inside of the tank at a level corresponding with that of oil 14. The skimmer 16 discharges the oil 14 through a discharge pipe 20 for suitable disposal of the oil.

The tank 10 is provided on its side with a sampling port 22 which allows samples of the fluid to be taken after the oil has been removed. The samples can be analyzed to determine if the fluid has the proper viscosity. If it does not, water from a suitable source may be added such as tap water supplied to line 24. The tap water may be pumped or otherwise passed from the source thereof into line 24 and through a conventional cation vessel 26 having ion exchange resins for deionizing the water. A transfer pipe 28 extends from the cation vessel 26 to a conventional anion vessel 30 through which the water is pumped for further ion exchange with ion exchange resins in the anion vessel 30. The water is passed from the anion vessel 30 through a meter 32 which supplies metered quantities of the deionized water into tank 10 through an inlet pipe 34. By metering the water through the meter 32, it is assured that the proper amount of water is supplied to the fluid in tank 10 to result in a proper viscosity of the water-glycol fluid. Again, samples can be taken through the sampling port 22 to assure that the viscosity is proper, and further water can be added if necessary to bring the viscosity to the desired level.

A pump 36 may be operated to pump the fluid out of the process tank 10 through a discharge pipe 38 which leads to the suction side of the pump from the lower part of tank 10. The pump 36 operates to pump the liquid through a pipe 40 which leads from the discharge side of the pump to a first particulate filter 42. The filter 42 is selected to filter out all particles that are larger that a given size. By way of example, it is preferred that the filter 42 be constructed to pass only particles that are smaller than five microns and to filter out larger particles.

The discharge side of the first particulate filter 42 connects with a pipe 44 that leads to a second particulate filter 46. The filter 46 is constructed to filter out smaller particles than the first filter 42. For example, it is preferred for filter 46 to be a one micron-filter which passes only particles that are smaller than one micron in size and filters out larger particles.

The discharge side of the second filter 46 connects with a pipe 48 that leads to a filter media bed 50 containing activated clay or another media that is capable of removing various contaminants. Activated clay is preferred because it is able to readily remove oil, grease, hydrocarbons, dissolved hydrocarbons, hydrolyzed acids, solvents and organic compounds which are materials that commonly contaminate the fire resistant hydraulic fluid.

The purified fluid that is discharged from the filter media bed 50, is passed through a pipe 52 that leads into the top portion of a finish tank 54. The finish tank 54 has on its side a sampling port 56 through which samples of the purified fluid can be taken. Additives that are specified by the manufacturer of the fire resistant hydraulic fluid can be added through an additive line 58 leading to a meter 60 which applies the additives in preselected metered amounts through a pipe 62 that extends to the top portion of the finish tank 54. Additional fluid samples can be taken through the sampling port 56 to assure that the additives are applied in an amount necessary to comply with the applicable specifications for the fluid.

In operation, the spent or contaminated water-glycol is applied to tank 10 through line 12 and allowed to settle so that the oil 14 collects on the surface. The oil is skimmed and removed by the skimmer 16, and water is deionized in the vessels 26 and 30 and added to the fluid in tank 10 if necessary, as determined by samples taken through the sampling port 22. Thereafter, the fluid is pumped by pump 36 through the particulate filters 42 and 46 to first remove the larger particles in filter 42 and then remove smaller particles in filter 46. The fluid then is passed through the filter media bed 50 which removes oil, grease, hydrocarbons, dissolved hydrocarbons, hydrolyzed acids, solvents and organic compounds. The purified fluid is then passed through line 52 into the finish tank 54, to which additives can be supplied in the desired amounts determined by the setting of the meter 60. In this way, spent or contaminated fire resistant hydraulic fluid is recycled and converted into a clean water-glycol fluid that can be put into service for use as a fire resistant hydraulic fluid.

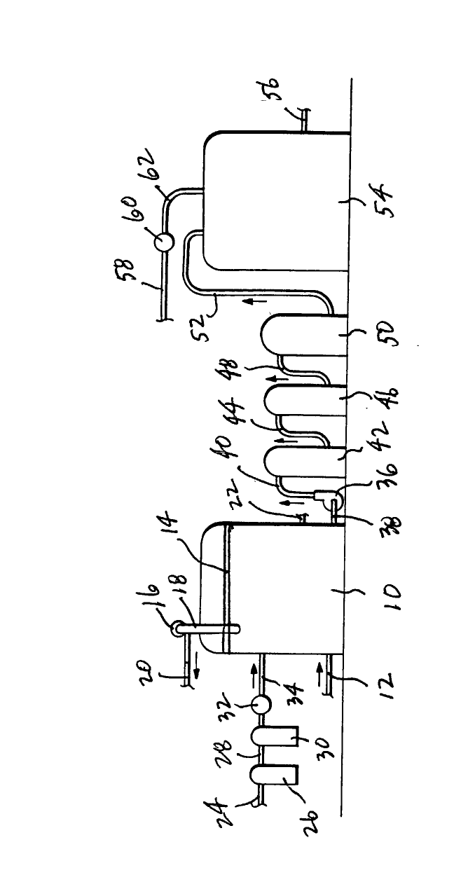

The apparatus shown in FIG. 1 can be provided in the form of a stationary installation. Alternatively, the equipment can be mounted on a truck or other mobile apparatus to enable it to be moved among different places of deployment.

From the foregoing it will be seen that this invention is one well adapted to attain all ends and objects hereinabove set forth together with the other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

What is claimed is:

1. A process for regenerating a previously used fire resistant hydraulic fluid comprising water-glycol, said process comprising the steps of:
directing the fluid into a tank;
removing free oil from the top of the fluid in the tank;
sampling the fluid to determine if the water content thereof is less than a preselected level;
adding water to the fluid to said preselected level if said sampling step determines a water content less than said preselected level;
filtering particulate material from the fluid; and
directing the fluid through a filter media bed to remove organic compounds.

2. A process as set forth in claim 1, wherein said water-glycol is selected from the group consisting of ethylene glycol and diethylene glycol.

3. A process as set forth in claim 1, including the step of allowing the fluid to settle in the tank so that the free oil therein collects on the top surface of the fluid in the tank.

4. A process as set forth in claim 3, wherein said step of removing free oil comprises:
skimming the free oil from the top surface of the fluid; and
directing the free oil that is skimmed out of the tank.

5. A process as set forth in claim 1, wherein said step of adding water to the fluid comprises:
supplying tap water from a source thereof;
deionizing the tap water; and
adding the deionized water to the tank.

6. A process as set forth in claim 5, wherein said step of deionizing the tap water comprises directing the tap water through cation and anion vessels.

7. A process as set forth in claim 1, wherein said step of filtering particulate material comprises:
passing the fluid through a first filter arranged to pass there through only particles less than a first selected size; and
thereafter passing the fluid through a second filter arranged to pass there through only particles less than a second selected size smaller than said first selected size.

8. A process as set forth in claim 7, wherein said first selected size is approximately 5 microns.

9. A process as set forth in claim 8, wherein said second selected size is approximately 1 micron.

10. A process as set forth in claim 7, wherein said second selected size is approximately 1 micron.

11. A process as set forth in claim 1, wherein said filter media bed is arranged to remove from the fluid oil, hydrocarbons, acids and solvents.

12. A process as set forth in claim 1, including the step of adding a prescribed additive to the fluid after said step of directing the fluid through the filter media bed.

13. A process as set forth in claim 1, wherein said filter media bed includes activated clay.

14. A process for regenerating water-glycol selected from the group consisting of ethylene glycol and diethylene glycol and used previously as a fire resistant hydraulic fluid, said process comprising the steps of:
directing the fluid into a process tank;
allowing the fluid to settle in the process tank long enough for free oil therein to float to the surface of the fluid and collect there;
removing free oil that collects on the surface of the fluid;
adding water to the fluid in the process tank if the viscosity of the fluid deviates from a selected viscosity level;
directing the fluid through a filter which is located outside of the tank and is arranged to filter particulate material;
directing the fluid through a filter media bed located downstream from said filter and arranged to remove organic compounds, oil and solvents from the fluid; and
directing the fluid into a finish tank.

15. A process as set forth in claim 14, wherein said filter comprises a first filter arranged to pass therethrough only particulate material below a first selected size and including a second filter arranged to pass therethrough only particulate material below a second selected size smaller than said first selected size, said second filter being located downstream from said first filter and upstream from said filter media bed.

16. A process as set forth in claim 14, wherein said filter media bed includes activated clay.

17. Apparatus for use in the regeneration of a previously used fire resistant hydraulic fluid comprising water-glycol, said apparatus comprising:
a process tank for receiving the fluid and allowing the fluid to settle therein to permit free oil to collect on the surface of the fluid;
means for skimming the free oil from the surface of the fluid in said tank;
a sampling port in said tank for sampling the fluid therein;
a controlled water inlet in said tank to allow water to be added to the fluid in the tank;
at least one filter outside of the tank arranged to filter particulate material from the fluid;
a filter media bed outside of the tank and downstream from said filter arranged to remove organic compounds from the fluid;
a finish tank for receiving and containing the regenerated fluid; and
means for pumping fluid from the tank through said filter and said filter media bed to said finish tank.

18. Apparatus as set forth in claim 17, including means for supplying deionized water to the tank through said controlled water inlet.

19. Apparatus as set forth in claim 17, wherein said finish tank has an additive inlet and including means for supplying a prescribed additive into the finish tank through said additive inlet.

20. Apparatus as set forth in claim 17, wherein:
said at least one filter comprises a first filter arranged to pass therethrough only particles less than a first selected size and a second filter arranged to pass therethrough only particles less than a second selected size smaller than said first selected size; and
said means for pumping is arranged to pump the fluid from the tank through said first filter, then through said second filter and then through said filter media bed to said finish tank.
